(19) United States
(12) Patent Application Publication
(10) Pub. No.: US 2014/0153124 A1
(43) Pub. Date: Jun. 5, 2014

(54) DOOR MIRROR

(71) Applicant: MURAKAMI CORPORATION, Shizuoka (JP)

(72) Inventor: Harutaka TSUKAMOTO, Shizuoka (JP)

(21) Appl. No.: 14/065,614

(22) Filed: Oct. 29, 2013

(30) Foreign Application Priority Data
Nov. 30, 2012 (JP) 2012-262912

(51) Int. Cl. B60R 1/06

(52) U.S. Cl. CPC B60R 1/06
USPC 359/872

(57) ABSTRACT

A door mirror has a frame mounted to a front surface of a door mirror housing and a door mirror storage unit installed at the frame. The door mirror includes an engagement piece formed at the frame and protruding in a direction of an axis of a rotational movement; and a receiving portion formed at a wall portion of the door mirror housing along the direction of the axis of the rotational movement and receiving the engagement piece from one direction of the axis of the rotational movement. The receiving portion is exposed to a front surface of the wall, and a stopping portion extending along the direction of the axis of the rotational movement and facing a front surface of the engagement piece is installed at the receiving portion.

### CROSS-REFERENCE TO RELATED APPLICATIONS

This application is based upon and claims the benefit of priority from Japanese Patent Application No. 2012-262912, filed Nov. 30, 2012, the entire contents of which are incorporated herein by reference.

### TECHNICAL FIELD

The present invention particularly relates to a door mirror in which a door mirror housing and a frame mounted to the door mirror housing are rotatable about an axis of a rotational movement of a door mirror storage unit.

### BACKGROUND

As such a technology as described above, a door mirror disclosed in Patent Document 1 (Japanese Patent Laid-Open Publication No. 2004-142635) has been known. The door mirror includes a door mirror housing and a frame configured to hold the door mirror housing. A driving device and a shaft are mounted to the frame. A base portion of the shaft is fixed to a door mirror base. A driving force of the driving device is transferred to the frame through the shaft, so that the frame and the door mirror housing are integrally rotated about the shaft.

An engagement portion for engaging the frame with the door mirror housing is formed at the door mirror described above. In the engagement portion, a locking piece formed at the frame is fitted into a locking hole formed at the door mirror housing. That is, the frame is fitted into the door mirror housing from a rear side of the door mirror housing. Further, the frame is fixed to the door mirror housing by a screw, etc.

### SUMMARY

The frame, the driving device, and the door mirror base are assembled in a direction extending along the axis of the shaft of the driving device due to structural reasons thereof. However, in the above-described door mirror according to the related art, the frame is mounted to the door mirror housing from the rear side. The “rear side” corresponds to the rear side of a vehicle in a state in which the door mirror is used. That is, the frame and the door mirror housing are assembled with each other in a direction approximately perpendicular to the axis of the shaft. Thus, when a plurality of components as described above are assembled, only the direction of assembling the door mirror housing and the frame with each other is different from the direction extending along the axis of the shaft. Therefore, there is a problem in that the door mirror according to the related art has a low working efficiency.

It is an object of the present invention to provide a door mirror in which the direction of assembling a door mirror housing and a frame is identical to the direction of assembling the other components, so as to improve a working efficiency thereof.

An aspect of the present invention is to provide a door mirror having a frame mounted to a front surface of a door mirror housing and a door mirror storage unit installed at the frame, the door mirror housing and the frame being integrally rotatable about an axis of a rotational movement of the door mirror storage unit, the door mirror including: an engagement piece formed at the frame and protruding in a direction of the axis of the rotational movement; and a receiving portion formed at a wall portion of the door mirror housing along the direction of the axis of the rotational movement and receiving the engagement piece from one direction of the axis of the rotational movement, wherein the receiving portion is exposed to a front surface of the wall portion, and a stopping portion extending along the direction of the axis of the rotational movement and facing a front surface of the engagement piece is installed at the receiving portion.

In this door mirror, an engagement piece protruding in the direction of the axis of the rotational movement of the door mirror storage unit is formed at the frame. The receiving portion for receiving the engagement piece from one direction of the axis of the rotational movement of the door mirror storage unit is formed at the wall portion of the door mirror housing along the direction of the axis of the rotational movement. Thus, when the frame is assembled at a front surface of the door mirror housing, the frame may be assembled from one direction of the axis of the rotational movement of the door mirror storage unit. Here, since the receiving portion is exposed to a front surface of the wall portion, the engagement piece is easily inserted into the receiving portion, thereby easily assembling the frame. Further, the stopping portion extending along the direction of the axis of the rotational movement and facing a front surface of the engagement piece is installed at the receiving portion of the door mirror housing. Thus, when the frame is assembled, the engagement piece disposed at the receiving portion is stopped by the stopping portion to be prevented from being moved forward. Accordingly, the frame is temporarily held at the door mirror housing. Thus, the door mirror housing and the frame may be moved to the next assembly process while preventing the frame from being separated from the door mirror housing. In the next assembly process, since components (for example, the door mirror base and the like) are assembled in the direction extending along the direction of the axis of the rotational movement of the door mirror storage unit, the directions of assembling the components are unified into one, thereby improving a work efficiency thereof. Meanwhile, the terms “front” of “front surface” and “front side” are based on a vehicle in a state where the door mirror is used.

The door mirror includes a screw insertion hole formed at the frame, through which a screw is inserted, and a screw hole formed on the front surface of the door mirror housing, with which the screw is screw-assembled. In the door mirror, the engagement piece is temporarily held by the receiving portion and the stopping portion installed at the receiving portion. The screw insertion hole and the screw hole are formed, thereby fixing the frame to the door mirror housing by screws.

A protrusion protruding forward around the screw hole is formed at the door mirror housing, and a locking portion facing an outer peripheral surface of the protrusion from another side of the direction of the axis of the rotational movement is formed at the frame. According to this configuration, since the stopping portion faces an outer peripheral surface of the protrusion from another direction of the axis of the rotational movement, the engagement piece of the frame is prevented from being moved toward one direction of the axis of the rotational movement. Thus, the engagement piece is prevented from being separated from the receiving portion so that the engagement piece is certainly coupled to the stopping portion. As a result, when the components are assembled, shaking of the door mirror housing with respect to the frame is reduced.

In accordance with an aspect of the present invention, the direction of assembling the door mirror housing and the frame with each other can be made to be the same as the direction of assembling the other components, so as to improve the work efficiency thereof.

### BRIEF DESCRIPTION OF THE DRAWINGS

FIG. 1 is a perspective view showing a door mirror according to a first embodiment of the present invention;

FIG. 2 illustrates a door mirror housing in which a frame is temporarily held when the door mirror of FIG. 1 is assembled, when viewed from a rear side;

FIG. 3 is a perspective view showing the door mirror housing and the frame of FIG. 2 when viewed from a front side;

FIG. 4 is a perspective view showing the door mirror housing of FIG. 3 when viewed from a front side;

FIG. 5 illustrates the frame of FIG. 3 when viewed from a front side;

FIG. 6 illustrates the frame of FIG. 3 when viewed from a rear side;

FIG. 7 is a schematic view showing the door mirror housing and the frame of FIG. 2 when viewed from a front side;

FIG. 8 is an enlarged perspective view showing a second fixing portion;

FIG. 9A is a sectional view taken along line IXA-IXA of FIG. 7, and FIG. 9B is a sectional view taken along line IXB-IXB of FIG. 7;

FIG. 10 is an enlarged perspective view showing a third fixing portion;

FIG. 11A is a sectional view taken along line XIA-XIA of FIG. 7, and FIG. 11B is a sectional view taken along line XIB-XIB of FIG. 7;

FIG. 12 is an enlarged perspective view showing an engagement portion;

FIG. 13 is a perspective view showing a state in which each component of the door mirror is assembled;

FIG. 14 illustrates a state in which the door mirror housing is assembled with the frame;

FIG. 15 is a perspective view showing a state in which the door mirror housing is held at the frame;

FIGS. 16A and 16B are perspective views showing a state before engaging of the second fixing portion, respectively;

FIG. 17A is a perspective view showing a state before engaging of the third fixing portion, FIG. 17B is a perspective view showing a state before engaging of an engagement portion, and FIG. 17C is a perspective view showing a state before a reference pin is inserted into a first fixing portion;

FIG. 18 illustrates a frame of a door mirror according to a second embodiment of the present invention when viewed from a rear side; and

FIG. 19 is a perspective view showing a state where components of the door mirror according to the second embodiment of the present invention are assembled.

### DETAILED DESCRIPTION

Hereinafter, embodiments of the present invention will be described with reference to the drawings. Further, in the description of the drawings, the same elements will be designated by the same reference numerals, and duplicate descriptions will be omitted. In the following description, the expressions “up and down”, “front and rear”, and “left and right” are based on a vehicle in a state where a door mirror is used.

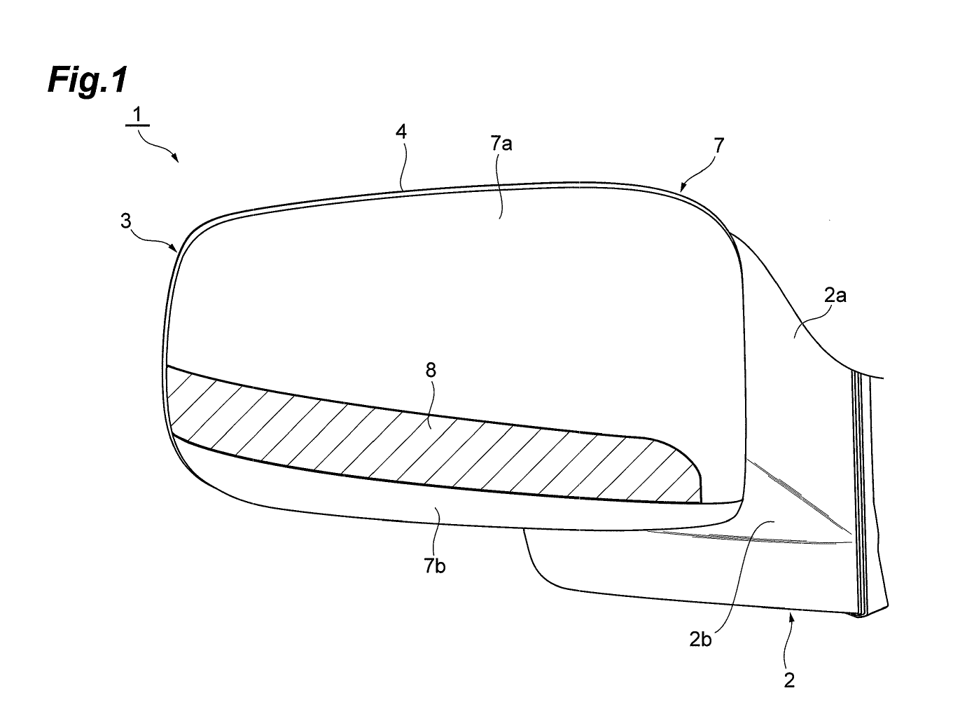

As shown in FIG. 1, a door mirror 1 for a vehicle (hereinafter, referred to simply as a door mirror) includes a door mirror base 2, which is made from resin and has a stand 2b horizontally extending from a base portion 2a fixed to a front door by bolting, and a door mirror body 3 mounted to the stand 2b of the door mirror base 2.

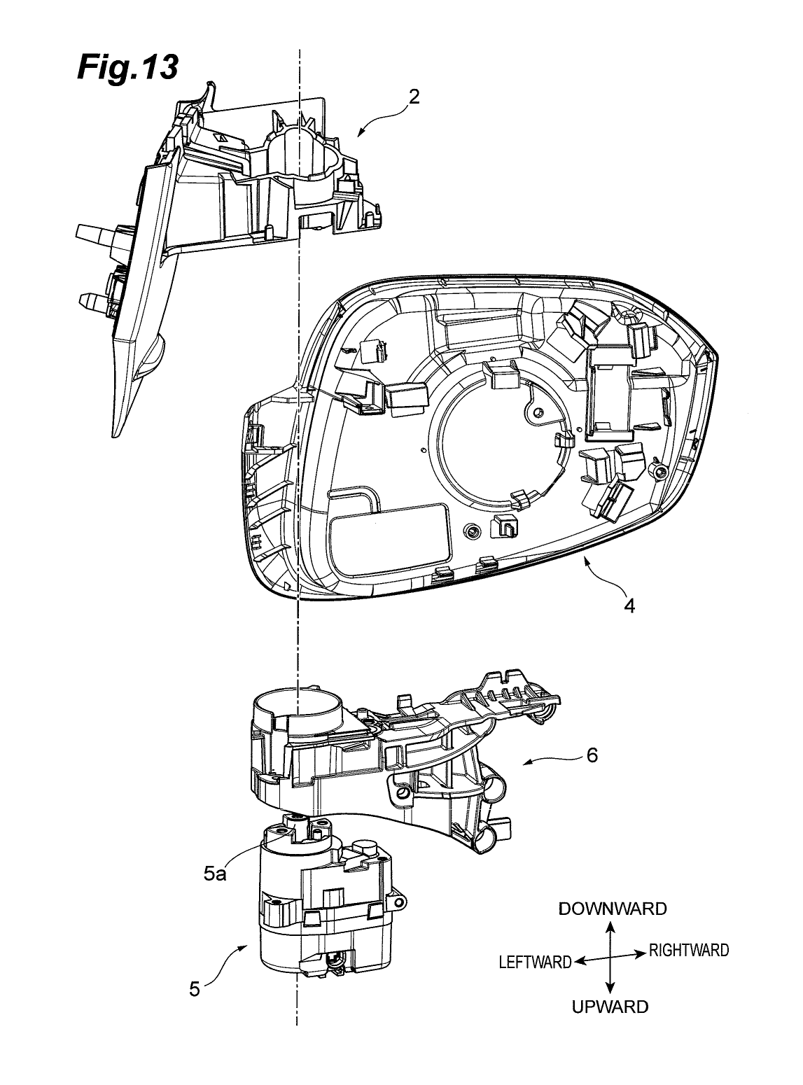

As shown in FIGS. 1 to 3, the door mirror body 3 includes a door mirror housing 4, which is made from resin and has a mirror disposed at an opening 4b of a rear side thereof, a frame 6, which is made from resin, is mounted to the front side of the door mirror housing 4, and supports the door mirror housing 4, an electrically-powered storage unit 5 (door mirror storage unit; see FIG. 13), which is fixed to the frame 6 and integrally rotates the door mirror housing 4 and the frame 6 with respect to the door mirror base 2, and a cover 7, which is made from resin and covers front sides of the door mirror housing 4 and the frame 6.

The door mirror housing 4 is formed of, for example, ABS resin and is formed by an integral molding. The frame 6 is formed of, for example, glass fiber-reinforced polyamide resin (PA+GF resin) which has a higher rigidity than that of the door mirror housing 4 and is formed by an integral molding. Meanwhile, the frame 6 may be an integrally-casted product formed of a metal such as aluminum.

As shown in FIG. 1, the cover 7 includes an upper cover 7a disposed at the upper side thereof, a lower cover 7b disposed at the lower side thereof, and a lamp assembly 8 constituting a side turn lamp. The upper cover 7a and the lower cover 7b are formed of, for example, ABS resin and are formed by an integral molding.

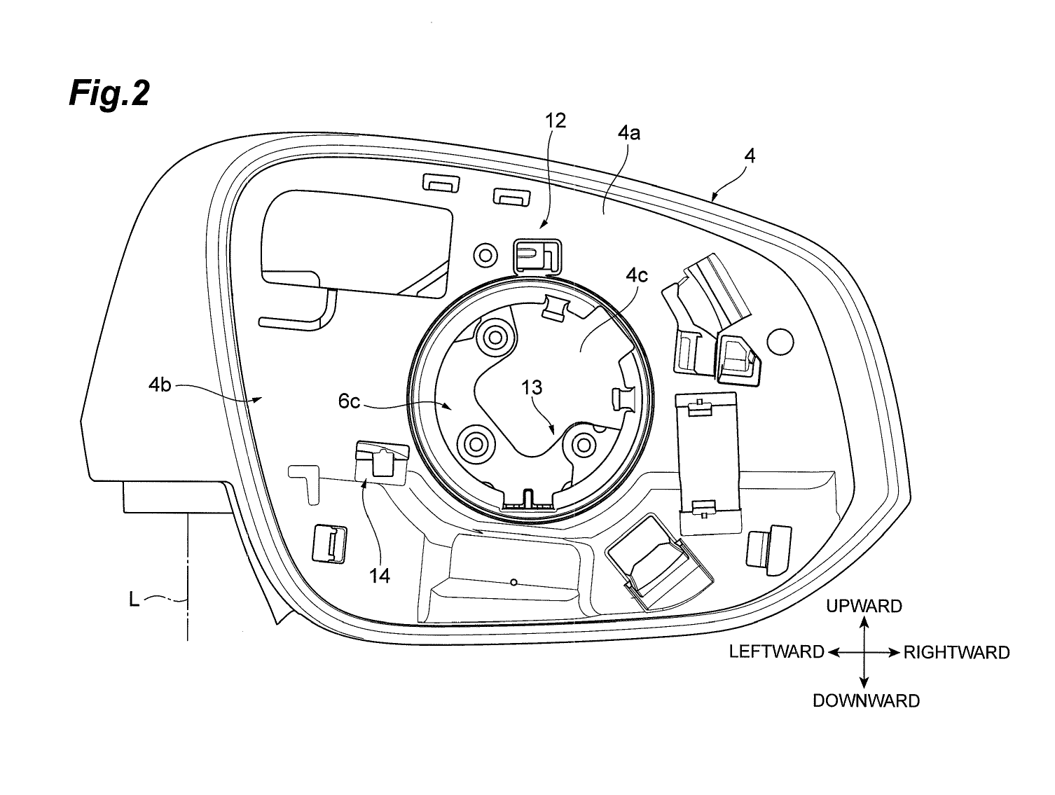

As shown in FIGS. 2 to 4, the door mirror housing 4 has a rectangular wall portion 4a extending in the up-down direction and in the left-right direction, a circular opening 4c formed at a central portion of the wall portion 4a, and a peripheral wall portion 4e extending rearward from a peripheral portion of the wall portion 4a and surrounding the mirror. The opening 4b of the rear side of the door mirror housing 4 is formed at a rear end of the peripheral wall portion 4e. The wall portion 4a is formed along an axis L of a rotational movement of the electrically-powered storage unit 5. A tilting mechanism of the mirror, etc., is installed within the door mirror housing 4. The tilting mechanism of the mirror is fixed to a mounting part 6c formed at an end of the frame 6 and exposed from the opening 4c of the door mirror housing 4 toward a rear side thereof.

The frame 6 is fixed to a front surface of the wall portion 4a. The electrically-powered storage unit 5 is inserted into and fixed to a storage unit receiving portion 6b of the frame 6. A shaft 5a (See FIG. 13) having the axis L of the rotational movement is installed at the electrically-powered storage unit 5. A lower end of the shaft 5a protrudes downward from the storage unit receiving portion 6b, and is fixed to the stand 2b (See FIG. 1) of the door mirror base 2 by a screw. The frame 6, the door mirror housing 4, and the cover 7 are rotatable about the axis L of the rotational movement with respect to the shaft 5a.

On the wall portion 4a, fixing portions 11, 12, and 13 and an engagement portion 14 for fixing the frame 6 are formed at a region from an area close to the opening 4c to a side of a vehicle. The fixing portions 11, 12, and 13 and the engagement portion 14 prevent the door mirror housing 4 and the frame 6 from being separated when the frame 6 and the door mirror housing 4 are assembled with each other. That is, the fixing portions 11, 12, and 13 and the engagement portion 14 serve to temporarily hold the frame 6 with respect to the door mirror housing 4 when the frame 6 and the door mirror housing 4 are assembled with each other.

In this way, in the door mirror 1, the frame 6 is fixed to the front surface of the wall portion 4a of the door mirror housing 4. Only the cover 7 (See FIG. 1) forming a design surface is disposed at a further front side of the frame 6 as a component relating to the structure. In other words, housings or other frames are not disposed between the frame 6 and the cover 7. A front wall portion for preventing falling of the frame, which is employed in the door mirror according to the related art, is not disposed on the front surface of the frame 6.

Thus, when the frame 6 and the door mirror housing 4 are assembled with each other, the frame 6 is engaged with only the wall portion 4a of which the front surface is exposed. By the temporarily holding function of the fixing portions 11, 12, and 13 and the engagement portion 14, the frame 6 (or the door mirror housing 4) does not easily fall down even before the frame 6 is fixed to the door mirror housing 4 by a screw.

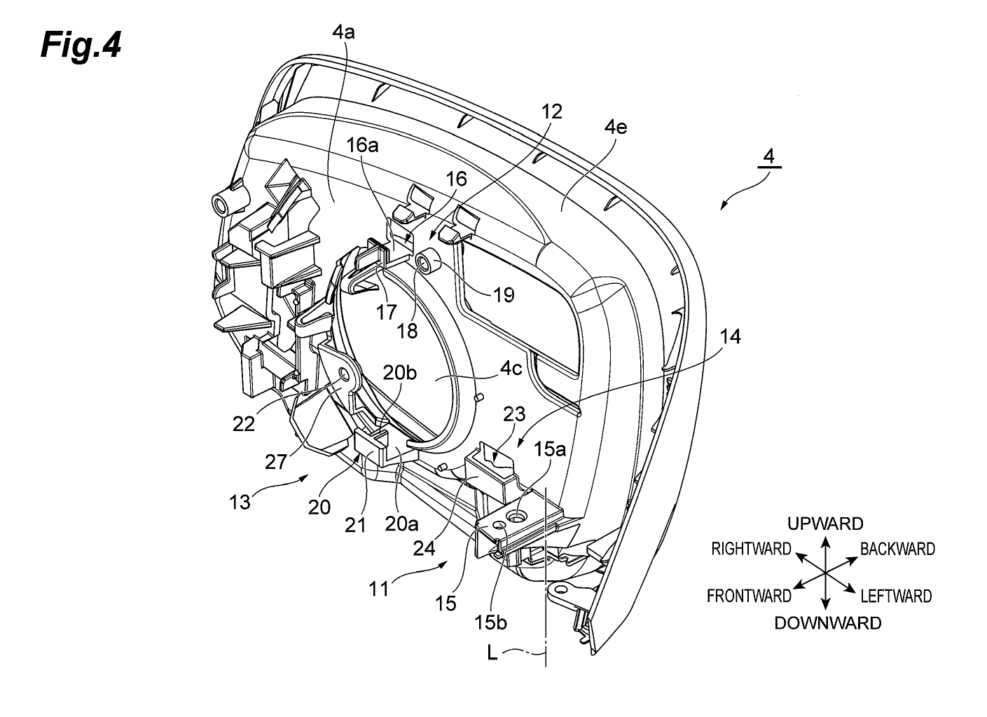

Hereinafter, the fixing portions 11, 12, and 13 and the engagement portion 14 will be described in more detail. As shown in FIG. 4, a rectangular support plate 15 horizontally protruding toward the front side thereof is formed at a lower portion of the wall portion 4a, which is close to the axis L of the rotational movement. A reference pin insertion hole 15a and a screw insertion hole 15b are formed at the support plate 15. The reference pin insertion hole 15a and the screw insertion hole 15b are formed through the support plate 15 in a depthwise direction (that is, the direction of the axis L of the rotational movement). The first fixing portion 11 for fixing (or temporarily holding) a portion of the frame 6 close to the axis L of the rotational movement to the wall portion 4a of the door mirror housing 4 is configured by the support plate 15 and the reference pin insertion hole 15a.

A receiving portion 16 protruding forward is formed just above the opening 4c of the wall portion 4a. The receiving portion 16 has a flat plate portion 16a, which has a rectangular shape and protrudes horizontally. An upper portion and opposite lateral portions of the receiving portion 16 are open. A stopping plate 17 (stopping portion), which has a rectangular shape, stands upright at a front end of the flat plate portion 16a. In other words, the stopping plate 17 extends along the direction of the axis L of the rotational movement.

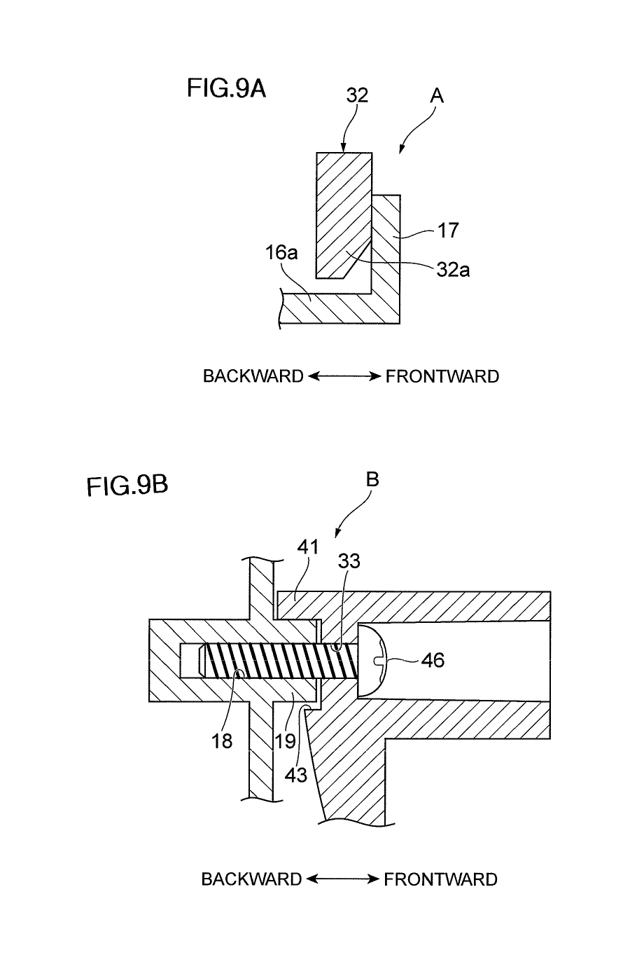

A screw hole 18 with which a screw 46 (See FIG. 9B) for fixing the frame 6 and the door mirror housing 4 is screw-assembled is formed through a portion close to the left side of the receiving portion 16. The screw hole 18 is formed along the front-back direction. A boss 19 (protrusion) protruding forward from the wall portion 4a is formed around the screw hole 18. The second fixing portion 12 for fixing (or temporarily holding) an upper portion of the frame 6 to the wall portion 4a of the door mirror housing 4 is configured by the stopping plate 17 and the boss 19.

A receiving portion 20 protruding forward is formed just below the opening 4c of the wall portion 4a. The receiving portion 20 has a flat plate portion 20a, which has a rectangular shape and protrudes horizontally. An upper portion and opposite lateral portions of the receiving portion 20 are open. A rectangular stopping plate 21 (stopping portion) stands upright at a front end of the flat plate portion 20a. In other words, the stopping plate 21 extends along the direction of the axis L of the rotational movement. In the receiving portion 20 and between the flat plate portion 20a and the stopping plate 21 which form an L-shape, a rectangular support plate portion 20b stands upright at a center of the left-right direction. In other words, the support plate portion 20b extends along the direction of the axis L of the rotational movement.

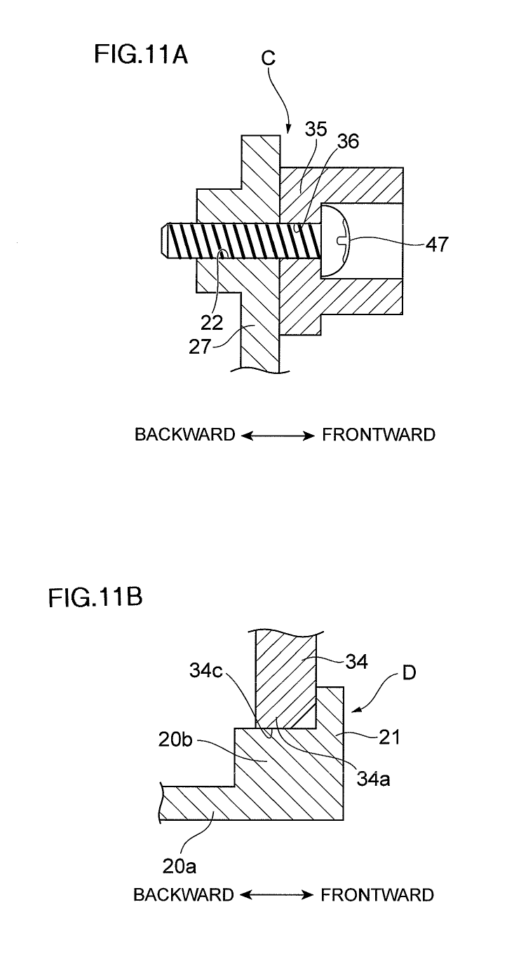

A screw hole 22 with which a screw 47 (See FIG. 11A) for fixing the frame 6 and the door mirror housing 4 is screw-assembled is formed through a portion close to a right side of the receiving portion 20. A triangular fixing plate portion 27 extending from a circumferential edge of the opening 4c toward the inside of the opening 4c is formed at the wall portion 4a. The fixing plate portion 27 is parallel to the wall portion 4a and is spaced apart from a surface of the wall portion 4a in the front-rear direction. The screw hole 22 is formed through the fixing plate portion 27 in the front-rear direction. A third fixing portion 13 for fixing (or temporarily holding) a lower portion of the frame 6, which is apart from the axis L of the rotational movement, to the wall portion 4a of the door mirror housing 4 is configured by the stopping plate 21, the support plate portion 20b, and the fixing plate portion 27.

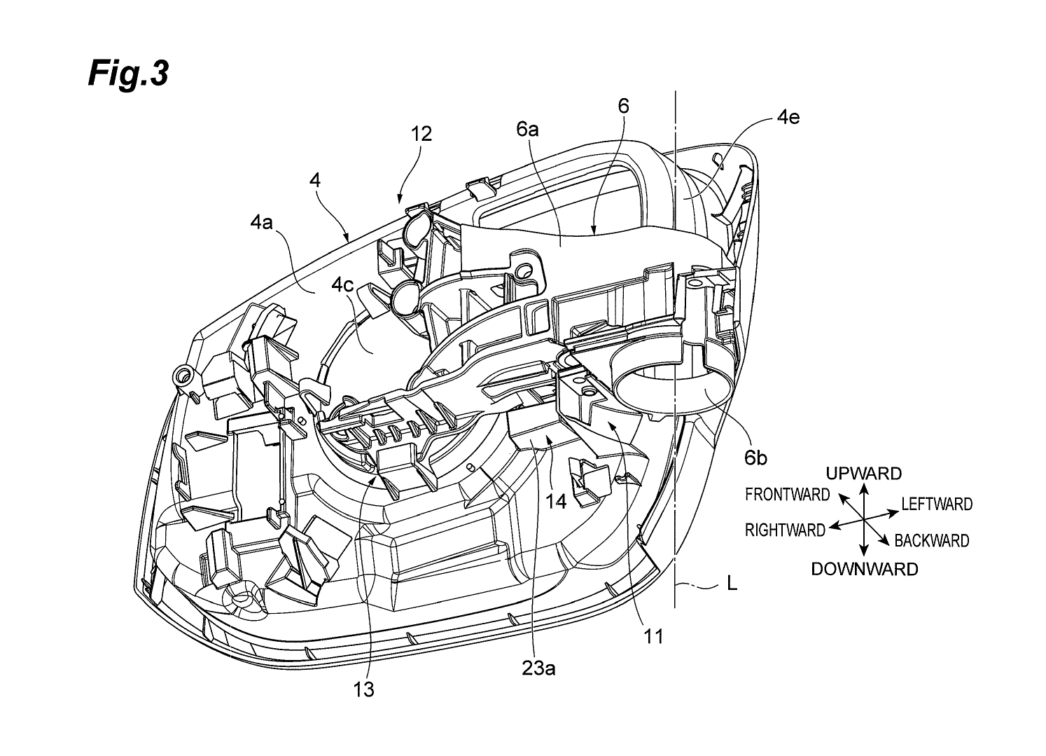

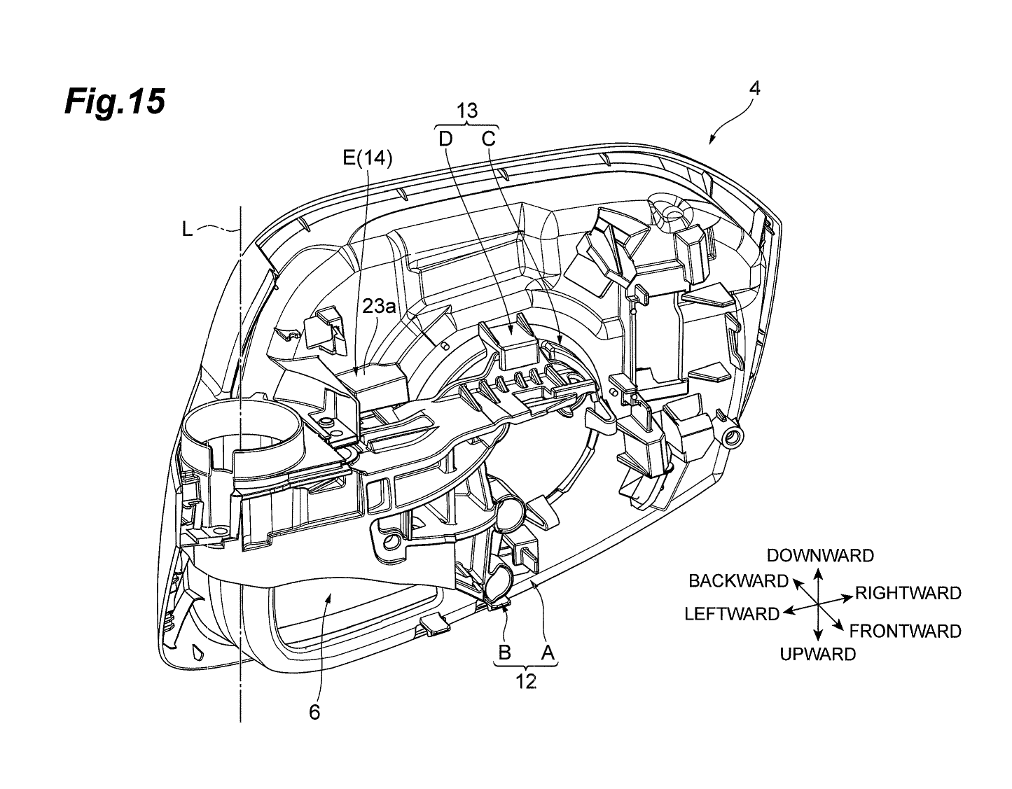

In the wall portion 4a, a receiving portion 23 protruding forward is formed between the support plate 15 and the receiving portion 20. The receiving portion 23 has a rectangular flat plate portion 23a (See FIG. 3 and FIG. 15) protruding horizontally. An upper portion of the receiving portion 23 is open. A rectangular stopping plate 24 (stopping portion) stands upright at a front end of the flat plate portion 23a. In other words, the stopping plate 24 extends along the direction of the axis L of the rotational movement. The engagement portion 14 for engaging (temporarily holding) a portion of the lower side of the frame 6 with the wall portion 4a of the door mirror housing 4 is configured by the stopping plate 24.

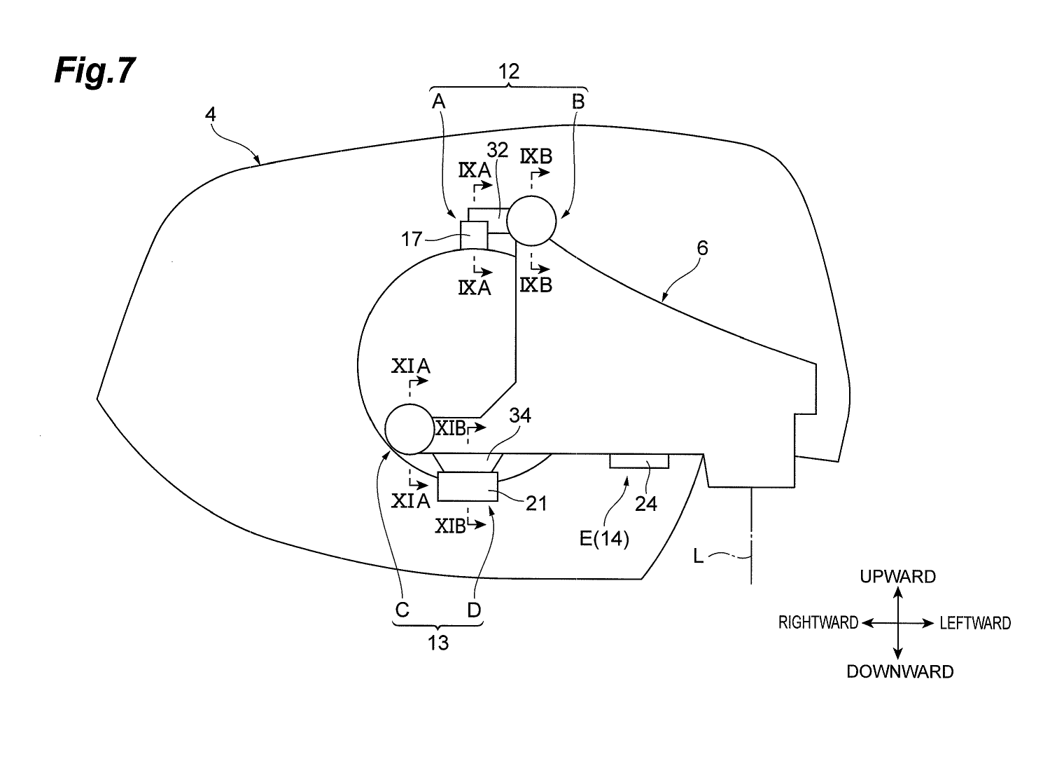

As described above, a plurality of temporarily-holding portions (the fixing portions 11 to 13) for temporarily holding the frame 6 when the frame 6 is assembled are installed at the wall portion 4a of the door mirror housing 4. Use of both these temporarily-holding portions and additional screws enables the main fixation of the frame 6 to the door mirror housing 4. The plurality of temporarily-holding portions are spaced apart from each other in the up-down direction and/or in the left-right direction. The first fixing portion 11, the second fixing portion 12, and the third fixing portion 13 are disposed at apexes of a triangle when viewed from the front side. The second fixing portion 12, the third fixing portion 13, and the engagement portion 14 are disposed at apexes of a triangle when viewed from the front side (See FIG. 7).

The receiving portion 16, the receiving portion 20, and the receiving portion 23 are exposed to the front surface of the wall portion 4a when the frame 6 is assembled. Since each of upper portions of the receiving portion 16, the receiving portion 20, and the receiving portion 23 is open, it is easy to assemble the frame 6 with the door mirror housing 4 from the upper portions thereof.

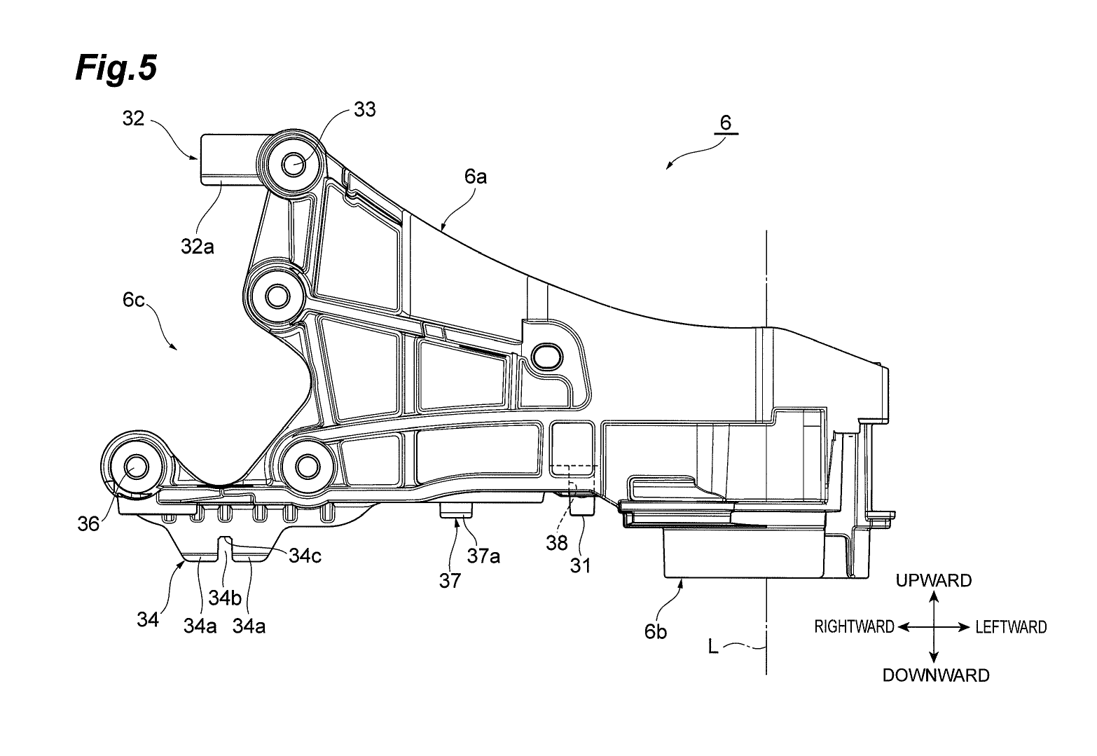

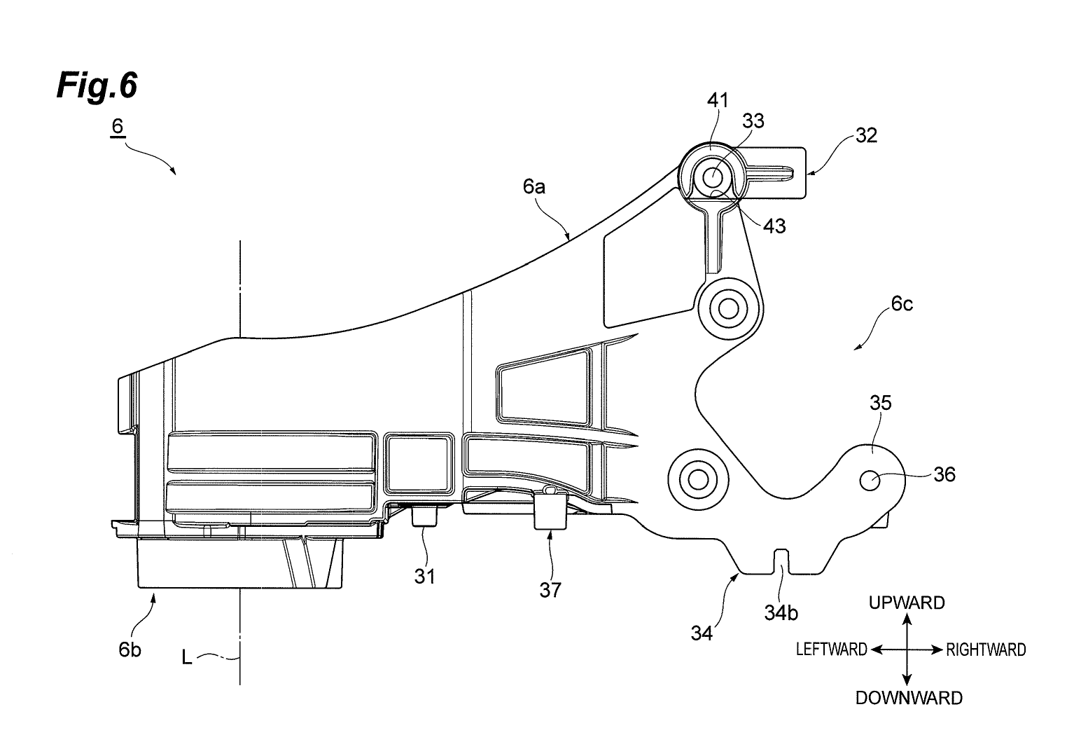

Now, the frame 6 will be described in detail. As shown in FIGS. 5 and 6, the frame 6 includes a frame body 6a, which is mounted to a region extending from an area close to the opening 4c of the door mirror housing 4 to a side of a vehicle and supports the door mirror housing 4, the cylindrical storage unit receiving portion 6b formed at the side of the axis L of the rotational movement of the frame body 6a, and the above-described mounting part 6c formed at an end opposite to the side of the axis L of the rotational movement of the frame body 6a. An axis of the storage unit receiving portion 6b coincides with the axis L of the rotational movement of the electrically-powered storage unit 5. The electrically-powered storage unit 5 is inserted from the upper side of the storage unit receiving portion 6b. Further, since the electrically-powered storage unit 5 and the frame 6 are actually assembled in a state in which they are inverted, the frame 6 is dropped into the electrically-powered storage unit 5 when the frame 6 is assembled (See FIG. 13).

A plurality of engagement pieces, which are engaged with the fixing portions 11, 12, and 13 and the engagement portion 14, are formed at the frame 6. Further, screw insertion holes 38, 33, and 36, through which screws in the fixing portions 11, 12, and 13 are inserted, are formed at the frame 6. In the fixing portions 12 and 13, the screw insertion holes 33 and 36 are disposed at lateral sides of the engagement pieces 32 and 34.

A cylindrical reference pin 31 protruding downward is formed at a lower portion of the frame body 6a, close to the axis L of the rotational movement. In other words, the reference pin 31 extends in the direction of the axis L of the rotational movement. The reference pin 31 is inserted through the reference pin insertion hole 15a (See FIG. 4) of the first fixing portion 11. The reference pin 31 has a position determining function when the frame 6 is mounted to the door mirror housing 4. As the reference pin 31 is inserted through the reference pin insertion hole 15a, the positions of the frame 6 in the left-right direction and the front-rear direction are determined.

The screw insertion hole 38 is formed at the front side of the reference pin 31. The reference pin 31 and the screw insertion hole 38 are arranged in parallel in the front-rear direction. The screw insertion hole 38 extends through a bottom plate portion of the frame body 6a in the direction of the axis L of the rotational movement. By a screw (not shown) inserted through the screw insertion hole 38 and the screw insertion hole 15b of the door mirror housing 4, the door mirror housing 4, the frame 6, and the electrically-powered storage unit 5 are assembled with each other, and the fixing at the first fixing portion 11 is performed.

The rectangular engagement piece 32 extending in the up-down direction and in the left-right direction is formed just above the mounting part 6c (that is, at a right upper end of the frame 6). The engagement piece 32 has a shape of a plate, and extends and protrudes rightward from the right upper end of the frame 6. In other words, the engagement piece 32 extends in the direction of the axis L of the rotational movement. The thickness of the engagement piece 32 becomes thinner as it goes downward. A tapered portion 32a the thickness of which becomes thinner as it goes downward is formed at the lower side of the engagement piece 32. The engagement piece 32 is disposed inside the receiving portion 16 (See FIG. 4) of the second fixing portion 12. A front-rear directional interval between a rear end of the stopping plate 17 and a front end of the boss 19 is equal to or less than the thickness of the engagement piece 32.

The screw insertion hole 33 through which the screw 46 (See FIG. 9B) is inserted is formed at an anchor side (left side) of the engagement piece 32. The screw insertion hole 33 is formed along the front-rear direction. The fixing at the second fixing portion 12 is performed by the screw 46 inserted through the screw insertion hole 33 and the screw hole 18 of the door mirror housing 4.

A semi-cylindrical guide wall 41 protruding backward from the upper side of the screw insertion hole 33 is formed at the frame 6. The guide wall 41 guides the boss 19 while being in contact with an outer peripheral surface of an upper portion of the boss 19. A semicircular locking step portion 43 (locking portion) slightly protruding rearward from the lower side of the screw insertion hole 33 is formed at the frame 6. The locking step portion 43 faces an outer peripheral surface of a lower portion of the boss 19 while being slightly spaced apart from the lower portion of the boss 19.

The rectangular engagement piece 34 extending in the up-down direction and in the left-right direction is formed just below the mounting part 6c (that is, at a right lower end of the frame 6). The engagement piece 34 has a shape of a plate, and protrudes downward from the right lower end of the frame 6. In other words, the engagement piece 34 extends in the direction of the axis L of the rotational movement. A U-shaped cutout portion 34b which is opened downward is formed at the engagement piece 34 at a central portion in the width direction, that is, in the left-right direction. The cutout portion 34b extends along the up-down direction, that is, along the direction of the axis L of the rotational movement. The thickness of the engagement piece 34 becomes thinner as it goes downward. Tapered portions 34a and 34a the thickness of which becomes thinner as they go downward are formed at the lower side of the engagement piece 34. The engagement piece 34 is disposed inside the receiving portion 20 (See FIG. 4) of the third fixing portion 13. A front-rear directional interval between a rear end of the stopping plate 21 and a front end of the fixing plate portion 27 is equal to or less than the thickness of the engagement piece 34.

The screw insertion hole 36 through which the screw 47 (See FIG. 11A) is inserted is formed at a distal end (right side) of the engagement piece 34. The screw insertion hole 36 is formed and extends through a distal end portion 35 of the frame 6 in the front-rear direction. The fixing at the third fixing portion 13 is performed by the screw 47 inserted through the screw insertion hole 36 and the screw hole 22 of the door mirror housing 4.

A rectangular engagement piece 37 extending in the up-down direction and in the left-right direction is formed between the reference pin 31 and the engagement piece 34. The engagement piece 37 has a shape of a plate and protrudes downward from a lower portion of the frame 6. In other words, the engagement piece 37 extends in the direction of the axis L of the rotational movement. The thickness of the engagement piece 37 becomes thinner as it goes downward. A tapered portion 37a the thickness of which becomes thinner as it goes downward is formed at the lower side of the engagement piece 37. The engagement piece 37 is disposed inside the receiving portion 23 (See FIG. 4) of the engagement portion 14.

Each of the engagement pieces 32, 34, and 37 is disposed at a rear side (back side) of the frame 6. Each of the engagement pieces 32, 34, and 37 is formed at a location protruding from the frame body 6a when viewed from a front side. In other words, each of the engagement pieces 32, 34, and 37 protrudes from the frame body 6a in the up-down direction (the direction of the axis L of the rotational movement) and/or in the left-right direction.

In the door mirror 1 having the door mirror housing 4 and the frame 6 as described above, the receiving portion 16 of the door mirror housing 4 receives the engagement piece 32 of the frame 6 from the above, and the stopping plate 17 is engaged with the engagement piece 32. The receiving portion 20 of the door mirror housing 4 receives the engagement piece 34 of the frame 6 from the above, and the stopping plate 21 is engaged with the engagement piece 34. The receiving portion 23 of the door mirror housing 4 receives the engagement piece 37 of the frame 6 from the above, and the stopping plate 24 is engaged with the engagement piece 37.

Further, in a state where the frame 6 is temporarily held by (or temporarily fixed to) the door mirror housing 4, or in a state where the frame 6 is fixed to the door mirror housing 4 by screws, the frame 6 cannot be moved in the front rear direction and in the left-right direction.

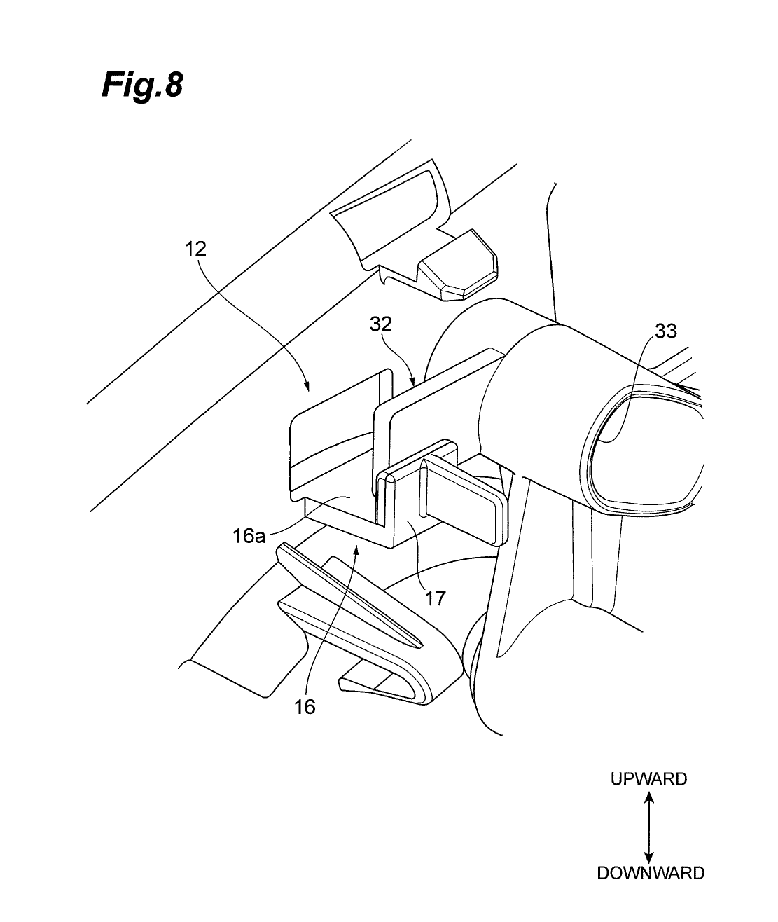

FIG. 7 is a schematic view showing the door mirror housing 4 and the frame 6 of FIG. 2 when viewed from a front side. FIG. 8 is an enlarged perspective view showing a second fixing portion 12. FIG. 9A is a sectional view taken along line IXA-IXA of FIG. 7, and FIG. 9B is a sectional view taken along line IXB-IXB of FIG. 7. As shown in FIG. 8 and FIG. 9A, a front surface of the engagement piece 32 is in contact with a rear surface of the stopping plate 17. Accordingly, a front holding portion A for holding the front side of the engagement piece 32 is formed. Further, as shown in FIG. 9B, a lower surface of the guide wall 41 is in contact with an upper surface of the boss 19. Accordingly, a lower holding portion B for holding the lower side of the guide wall 41 is formed. The second fixing portion 12 is configured by the front holding portion A and the lower holding portion B.

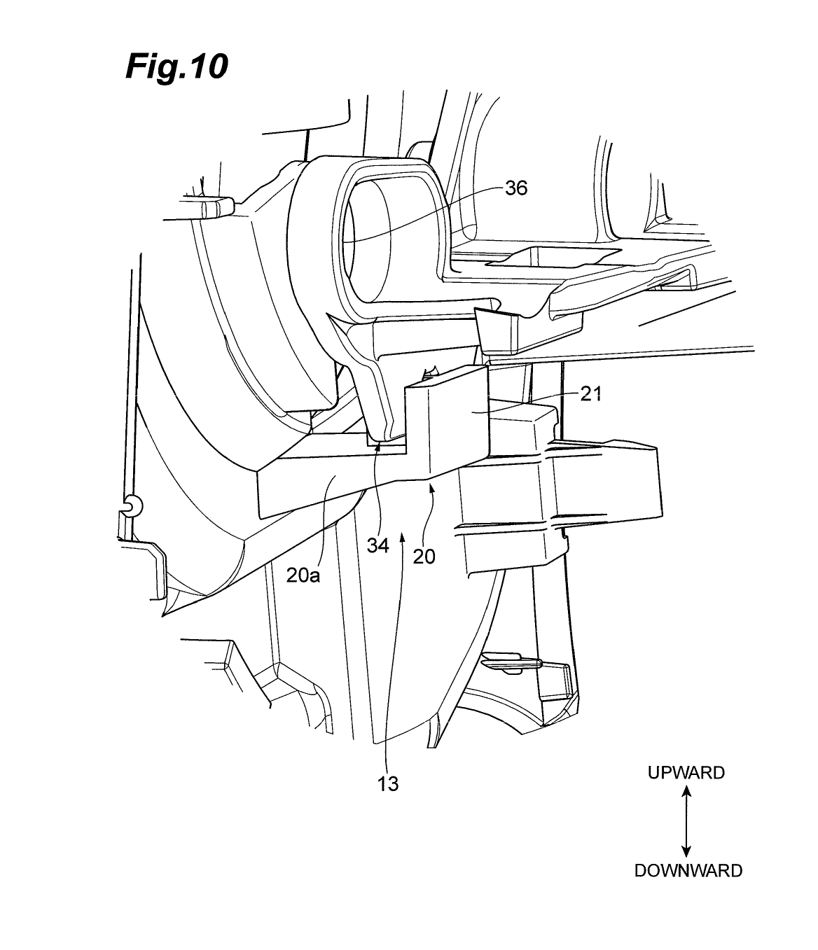

FIG. 10 is an enlarged perspective view showing a third fixing portion 13. FIG. 11A is a sectional view taken along line XIA-XIA of FIG. 7, and FIG. 11B is a sectional view taken along line XIB-XIB of FIG. 7. As shown in FIGS. 10 and 11A, a rear surface of the distal end portion 35 of the frame 6 is in contact with a front surface of the fixing plate portion 27. Accordingly, a rear holding portion C for holding the rear side of the distal end portion 35 is formed. Further, as shown in FIG. 11B, a valley portion 34c (See FIG. 5) of the cutout portion 34b formed at the engagement piece 34 is in contact with an upper end of the support plate portion 20b. Further, a front surface of the engagement piece 34 is in contact with a rear surface of the stopping plate 21 (not shown). Accordingly, a lower-front holding portion D for holding the lower side and the front side of the engagement piece 34 is formed. The third fixing portion 13 is formed by the rear holding portion C and the lower-front holding portion D.

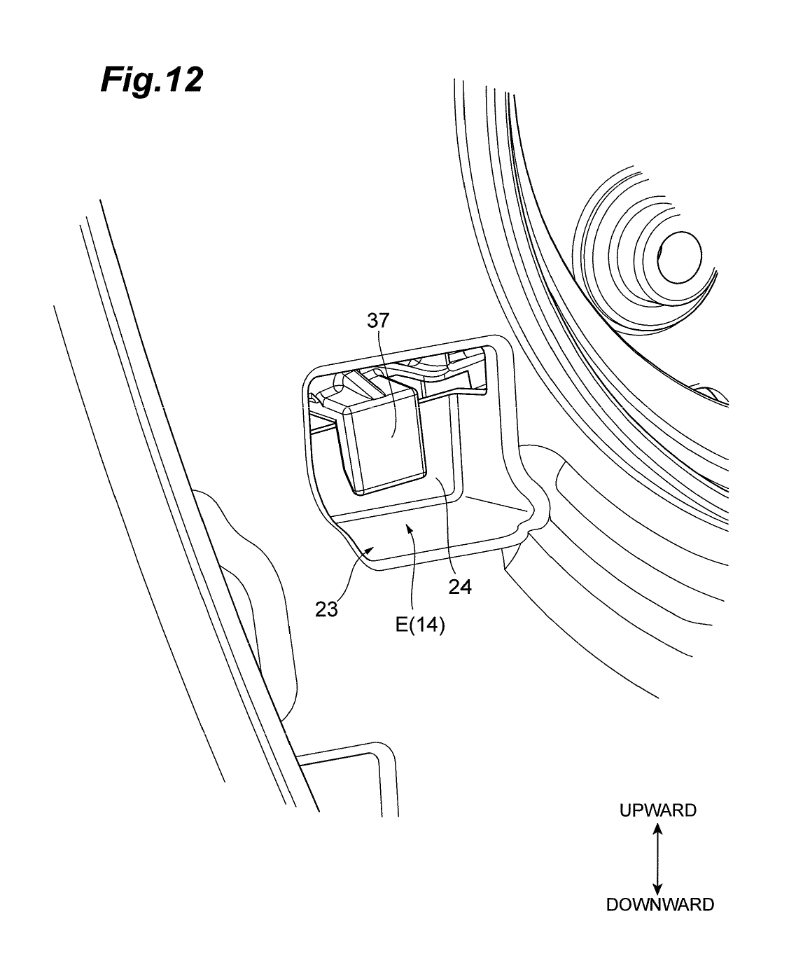

As shown in FIG. 12, a front surface of the engagement piece 37 is in contact with a rear surface of the stopping plate 24. As a result, a front holding portion E (that is, the engagement portion 14) for holding the front side of the engagement piece 37 is formed.

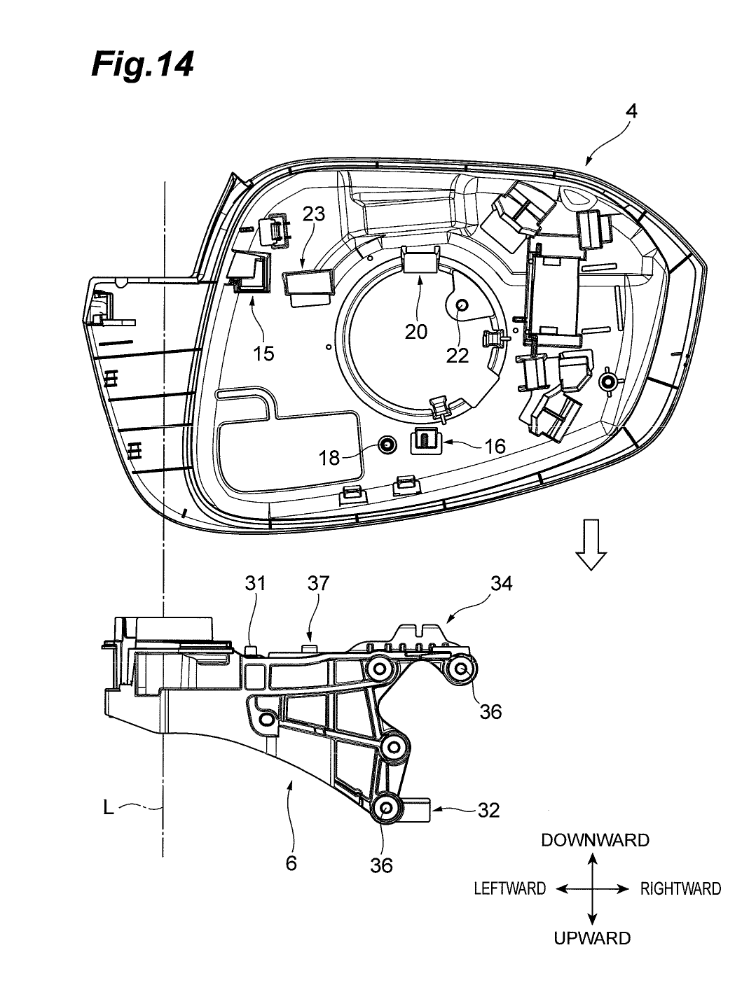

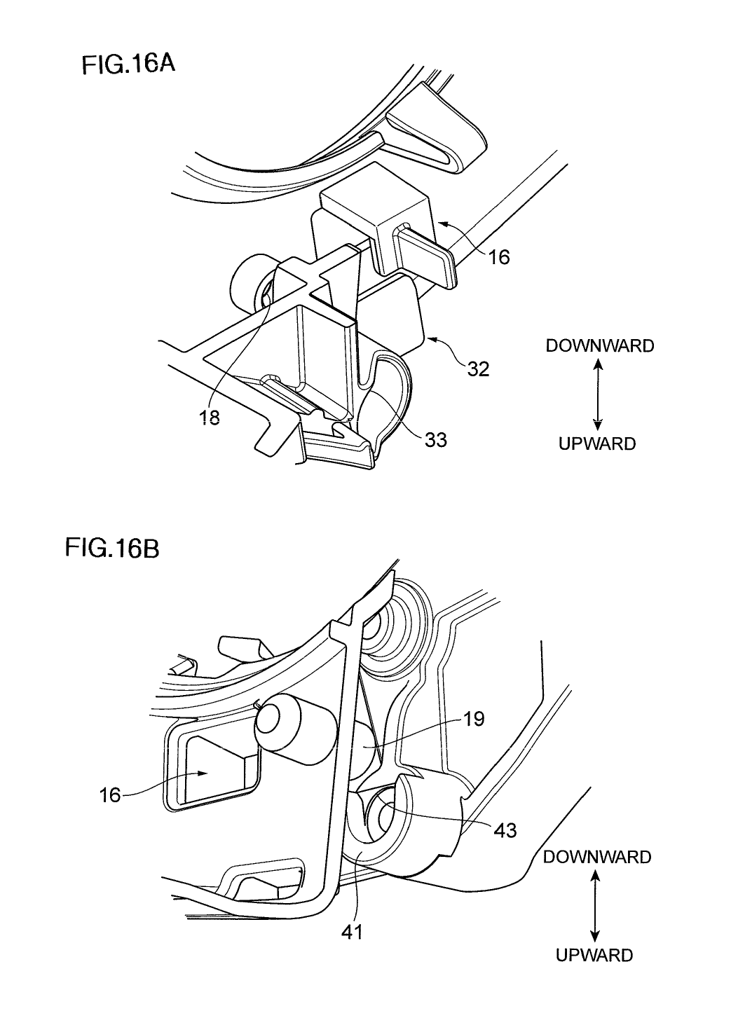

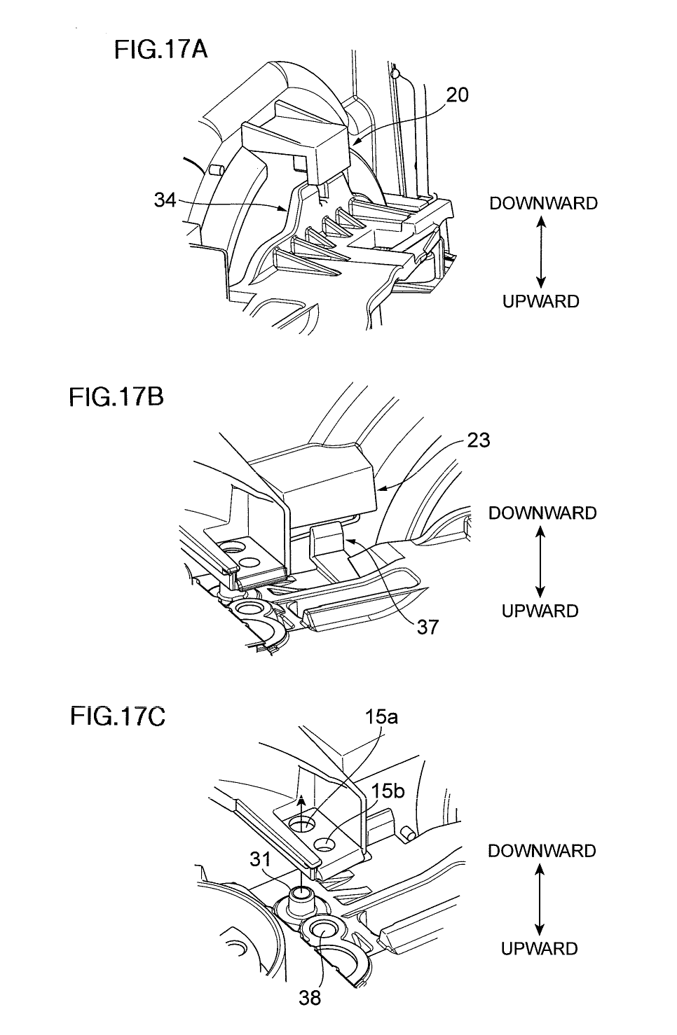

Next, a method of assembling the door mirror 1 will be described. The door mirror 1 is assembled in a state in which it is inverted. First, the door mirror housing 4 and the frame 6 are assembled with each other. As shown in FIG. 14, the door mirror housing 4 is dropped to be inserted. Accordingly, the reference pin 31 is inserted into the reference pin insertion hole 15a of the support plate 15 (See FIG. 17C), the engagement piece 34 is inserted into the receiving portion 20 (See FIG. 17A), the engagement piece 37 is inserted into the receiving portion 23 (See FIG. 17B), and the engagement piece 32 is inserted into the receiving portion 16 (See FIG. 16A). At the same time, the screw insertion hole 15b is made to communicate with the screw insertion hole 38 (See FIG. 17C), the screw hole 22 is made to communicate with the screw insertion hole 36 (See FIG. 11A), and the screw hole 18 is made to communicate with the screw insertion hole 33 (See FIG. 16A). Then, as shown in FIG. 16B, the engagement piece 32 is inserted into the receiving portion 16 such that an upper surface (shown lower surface) of the boss 19 is aligned with a lower surface (shown upper surface) of the guide wall 41.

In a state (See FIG. 15) where the door mirror housing 4 is temporarily held with respect to the frame 6, the frame 6 and the door mirror housing 4 are dropped and inserted from the direction of the axis L of the rotational movement with respect to the electrically-powered storage unit 5 (See FIG. 13). Further, the door mirror base 2 is dropped and inserted in the direction of the axis L of the rotational movement with respect to a lower end of the electrically-powered storage unit 5 protruding from the frame 6.

Thereafter, the door mirror base 2, the electrically-powered storage unit 5, the frame 6, and the door mirror housing 4 are integrally assembled by screw-fixing, and the cover 7 is inserted. Then, the assembly of the door mirror 1 shown in FIG. 1 is completed.

In the door mirror 1, the engagement pieces 32 and 34 protruding toward the direction of the axis L of the rotational movement of the electrically-powered storage unit 5 are formed at the frame 6. The receiving portions 16 and 20 for receiving the engagement pieces 32 and 34 from the above are formed at the wall portion 4a of the door mirror housing 4 along the direction of the axis L of the rotational movement. Thus, when the frame 6 is assembled on a front surface of the door mirror housing 4, the frame 6 may be assembled from the above. Here, since the receiving portions 16 and 20 are exposed to a front surface of the wall portion 4a, it is easy to insert the engagement pieces 32 and 34 into the receiving portions 16 and 20, thereby easily assembling the frame 6. Further, the stopping plates 17 and 21 extending along the direction of the axis L of the rotational movement and facing front surfaces of the engagement pieces 32 and 34 are installed at the receiving portions 16 and 20 of the door mirror housing 4. Thus, when the frame 6 is assembled, the engagement pieces 32 and 34 disposed inside the receiving portions 16 and 20 are stopped by the stopping plates 17 and 21 so that front directional movement thereof is prevented. Accordingly, the frame 6 is temporarily held at the door mirror housing 4. Thus, the door mirror housing 4 and the frame 6 may be moved to the next assembly process while preventing the frame 6 from being separated from the door mirror housing 4. In the next assembly process also, components (for example, the door mirror base 2 and the like) are assembled along the direction of the axis L of the rotational movement of the electrically-powered storage unit 5. Therefore, the assembling direction is unified, to thereby improve the work efficiency thereof.

In the door mirror housing 4, the front wall portion according to the related art is unnecessary so that the degree of freedom in the design shape of the cover 7 (especially, the lower cover 7b or the lamp assembly 8) increases. In addition, the situation where a portion of the front wall portion becomes a molded undercut area is prevented and the undercut is eliminated, so as to make it easy to manufacture a molding.

The fixing portions of the door mirror housing 4 and the frame 6 are divided into (1) the lower holding portion 13 for holding the lower side of the frame 6 and the front holding portion A for holding the front side of the frame 6 and (2) the lower-front holding portion D for holding the lower and front side of the frame 6 and the rear holding portion C for holding the rear side of the frame 6. Therefore, such a large holding portion (a frame disposing portion including the front wall portion) as in the related art, having a structure in which all elements are integrally formed, is unnecessary.

In the door mirror 1, the engagement pieces 32 and 34 are temporarily held by the receiving portions 16 and 20 and the stopping plates 17 and 21. The screw insertion holes 33 and 36 and the screw holes 18 and 22 are formed at lateral sides of the engagement pieces so that the frame 6 can be fixed to the door mirror housing 4 by the screws 46 and 47.

As the screw insertion holes 33 and 36 and the screw holes 18 and 22 are placed nearer to the positions of engagement between the engagement pieces 32 and 34 and the receiving portions 16 and 20, the likelihood that position deviation occurs between the screw holes 18 and 22 and the screw insertion holes 33 and 36 decreases. As the screw insertion holes 33 and 36 and the screw holes 18 and 22 are formed at an area close to the positions of engagement between the engagement pieces 32 and 34 and the receiving portions 16 and 20, it is easy to determine the positions of the screw insertion holes 33 and 36 with respect to the screw holes 18 and 22. Thus, it is easy to perform the fixing by screws 46 and 47, which further improves the work efficiency thereof.

Since the locking step portion 43 is disposed at the lower side of the boss 19 and faces the outer peripheral surface of the boss 19, the locking step portion 43 is in contact with the boss 19 from the lower side thereof when the frame 6 is moved upward. Thus, the engagement piece 32 of the frame 6 is prevented from being moved upward so that the engagement piece 32 is prevented from being separated from the receiving portion 16. Accordingly, the engagement piece 32 is certainly engaged with the stopping plate 17. As a result, when the components are assembled with each other, shaking of the door mirror housing 4 with respect to the frame 6 is reduced.

The tapered portion 32a is formed at the lower side of the engagement piece 32, and the tapered portions 34a are formed at the lower side of the engagement piece 34, so as to reduce catching of the lower side of the engagement pieces 32 and 34 with respect to the stopping plates 17 and 21, thereby making it easy to insert the engagement pieces 32 and 34 into the receiving portions 16 and 20.

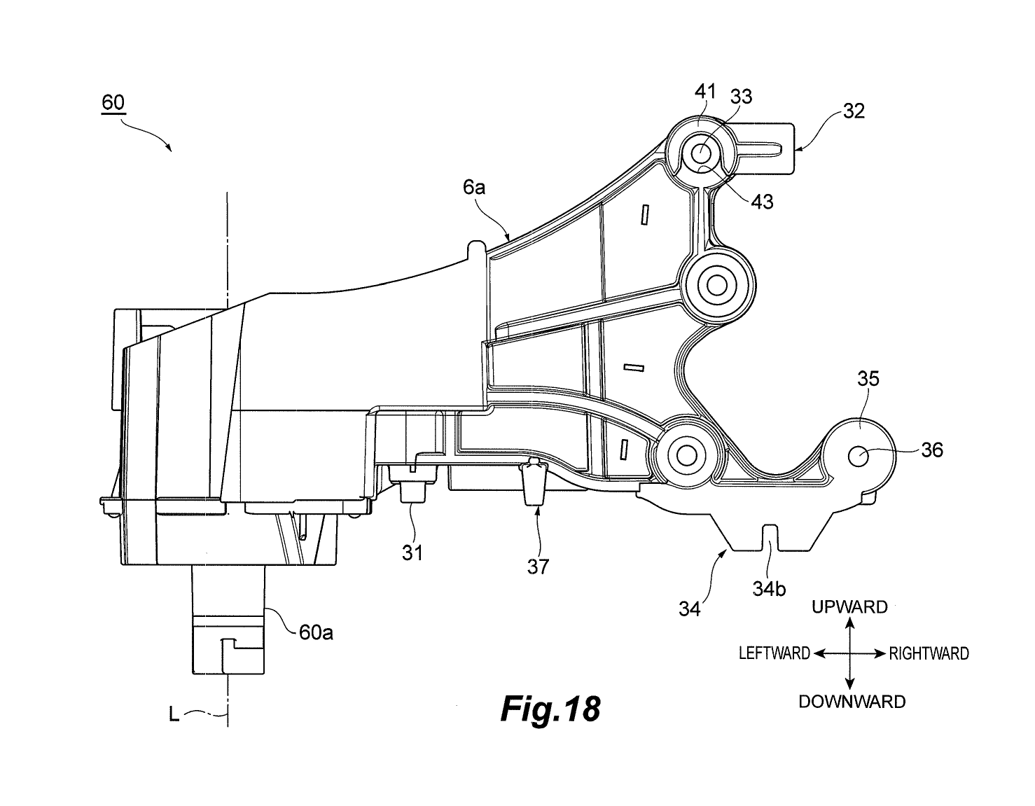

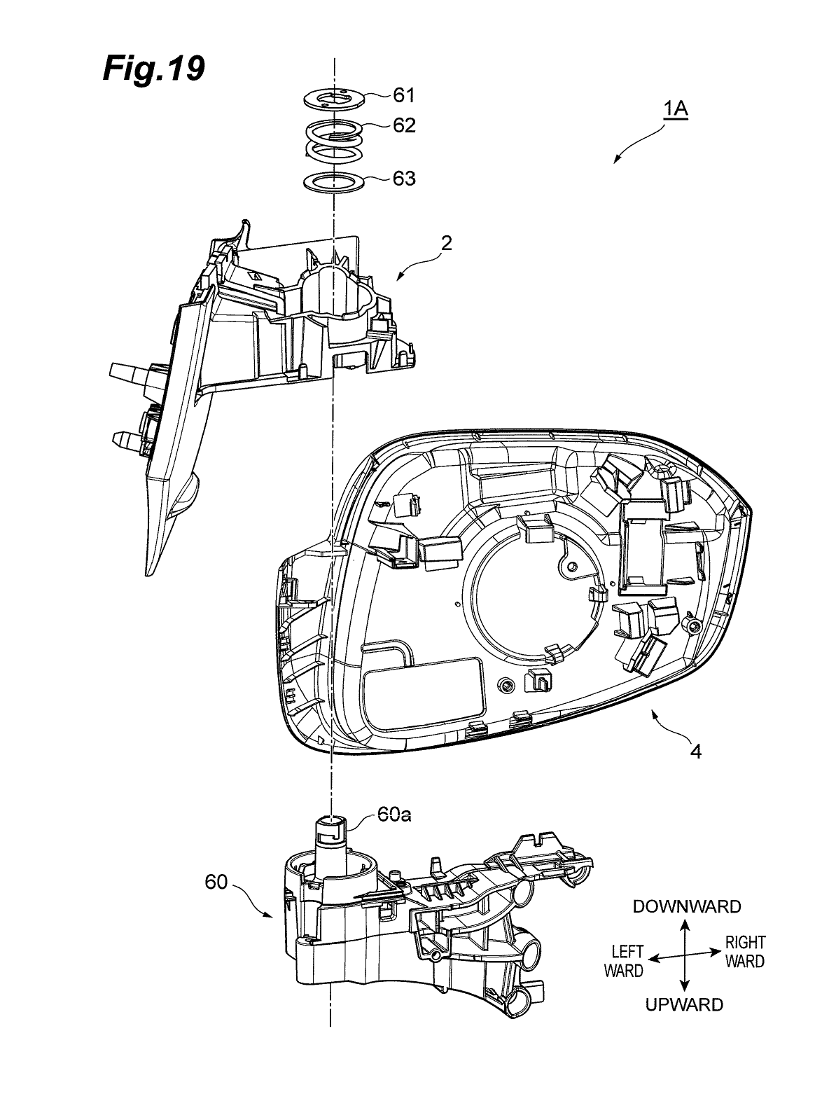

Hereinafter, a door mirror 1A according to a second embodiment of the present invention will be described with reference to FIGS. 18 and 19. The door mirror 1A is different from the door mirror 1 according to the first embodiment of the present invention in that the door mirror 1A includes a manual storage unit 60 instead of the electrically-powered storage unit 5. A shaft 60a is formed by an integral molding the manual storage unit 60. The door mirror base 2 is a base commonly used for the manual storage and the electrically-powered storage. An annular plate 61, a coil-shaped spring 62, and an annular washer 63 are installed inside the door mirror base 2 in which a lower end of the shaft 60a is inserted.

In the door mirror 1A, the directions of assembling the door mirror base 2, the door mirror housing 4, the frame 6, the plate 61, the spring 62, and the washer 63 are unified into one, thereby improving the working efficiency thereof, as in the door mirror 1.

In the above description, although the embodiments of the present invention have been described, the present invention is not limited thereto. For example, although the screw insertion hole and the screw hole are formed at locations close to the lateral side of the engagement piece in the above described embodiment, the screw insertion hole and the screw hole may be formed at locations far from the engagement piece. Further, although a plurality of the fixing portions 12 and 13 are formed in the above described embodiment, only one fixing portion may be formed at one point. The reference pin 31 may be omitted. The locking step portion (the locking portion) may be omitted.

What is claimed is:

1. A door mirror having a frame mounted to a front surface of a door mirror housing and a door mirror storage unit installed at the frame, the door mirror housing and the frame being integrally rotatable about an axis of a rotational movement of the door mirror storage unit, the door mirror comprising:
an engagement piece formed at the frame and protruding in a direction of the axis of the rotational movement; and
a receiving portion formed at a wall portion of the door mirror housing along the direction of the axis of the rotational movement and receiving the engagement piece from one direction of the axis of the rotational movement,
wherein the receiving portion is exposed to a front surface of the wall portion, and a stopping portion extending along the direction of the axis of the rotational movement and facing a front surface of the engagement piece is installed at the receiving portion.

2. The door mirror according to claim 1, comprising:
a screw insertion hole formed at the frame, through which a screw is inserted; and
a screw hole formed on the front surface of the door mirror housing, with which the screw is screw-assembled.

3. The door mirror according to claim 2, wherein
a protrusion protruding forward from a portion around the screw hole is formed at the door mirror housing; and
a locking portion facing an outer peripheral surface of the protrusion from another side of the direction of the axis of the rotational movement is formed at the frame,

4. The door mirror according to claim 3, wherein a gap is formed between the locking portion and the outer peripheral surface of the protrusion.

5. The door mirror according to claim 1, wherein the front surface of the engagement piece is in contact with a rear surface of the stopping portion.

6. The door mirror according to claim 1, wherein
a reference pin extending along the direction of the axis of the rotational movement is formed at the frame,
a reference pin insertion hole protruding forward, through which the reference pin is inserted, is formed at the wall portion of the door mirror housing, and
positions of the frame in the left-right direction and in the front-rear direction are determined as the reference pin is inserted through the reference pin insertion hole.

7. The door mirror according to claim 1, wherein only a cover constituting a design surface is disposed on a front surface of the frame as a component relating to the structure.
